(19) United States
(12) Patent Application Publication
(10) Pub. No.: US 2026/0270780 A1
(43) Pub. Date: Sep. 10, 2026

(54) DISCARD TIMER ENHANCEMENTS FOR EXTENDED REALITY COMMUNICATIONS

(71) Applicant: Lenovo (Singapore) Pte. Limited, Singapore (SG)

(72) Inventors: Joachim Löhr, Wiesbaden (DE); Prateek Basu Mallick, Dreieich (DE); Hyung-Nam Choi, Ottobrunn (DE); Ravi Kuchibhotla, Chicago, IL (US)

(73) Assignee: Lenovo (Singapore) Pte. Limited, Singapore (SG)

(21) Appl. No.: 19/471,286

(22) PCT Filed: Apr. 4, 2024
(86) PCT No.: PCT/IB2024/053315

§ 371 Date: Sep. 30, 2025

Related U.S. Application Data
(60) Provisional application No. 63/494,082, filed on Apr. 4, 2023.

(51) Int. Cl. H04W 28/06; H04W 28/02

(52) U.S. Cl. CPC H04W 28/06; H04W 28/0284

(57) ABSTRACT

Various aspects of the present disclosure relate to an apparatus for discard timer enhancements for extended reality communications. The apparatus receives a first signaling as a configuration from a radio access network (RAN). The configuration indicating a plurality of sets of timer configuration s for a plurality of importance levels. The apparatus applies a first set of timer configurations of the plurality of sets for data of a radio bearer. The apparatus applies, in response to receipt of a message from the RAN, a second set of timer configurations of the plurality of sets for the data of the radio bearer.

### RELATED APPLICATION

This application claims priority to U.S. Provisional Application Ser. No. 63/494,082 filed Apr. 4, 2023 entitled “Discard Timer Enhancements for Extended Reality Communications,” the disclosure of which is incorporated by reference herein in its entirety.

### TECHNICAL FIELD

The present disclosure relates to wireless communications, and more specifically to extended reality communications.

### BACKGROUND

A wireless communications system may include one or multiple network communication devices, such as base stations, which may be otherwise known as an eNodeB (eNB), a next-generation NodeB (gNB), or other suitable terminology. Each network communication device, such as a base station, may support wireless communications for one or multiple user communication devices, which may be otherwise known as user equipment (UE), or other suitable terminology. The wireless communications system may support wireless communications with one or multiple user communication devices by utilizing resources of the wireless communications system, such as time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

In a wireless communications system, extended reality (XR) use cases are associated with certain network requirements and/or communications traffic. XR is an umbrella term for different types of human-machine interactions generated by a computer technology, such as virtual reality (VR), augmented reality (AR), and/or mixed reality (MR).

### SUMMARY

The present disclosure relates to methods, apparatuses, and systems that support discard timer enhancements for XR communications. The described techniques enable a wireless communications system to avoid or reduce congestion associated with XR communications over an air interface (e.g., for uplink (UL) transmissions), for example, by configuring multiple packet data convergence protocol (PDCP) discard timer configurations for different importance levels of different protocol data unit (PDU) and/or PDU sets. For instance, quality-of-service (QoS) flow and/or radio bearer for XR traffic may carry PDU sets with different importance levels (e.g. intra-coded picture (I-frames) and predicted picture (P-frames) of a video stream). Accordingly, aspects of the disclosure are directed to distinguished handling of PDU sets based on importance. As an example, a different discard timer configuration can be applied for data that has a higher importance level than data that has a lower importance level. As another example, during congestion periods, a system may prioritize high importance data while discarding low importance data.

By adjusting discard timer configurations on the basis of importance level and/or network conditions, a communication device may experience improved user experience, low latency, and/or high reliability for wireless communications, especially with respect to use cases such as XR communications and/or other types of high throughput data communications (e.g., video and/or audio streaming).

In some implementations of the method and apparatuses described herein, a UE receives a first signaling as a configuration from a radio access network (RAN), the configuration indicating a plurality of sets of timer configurations for a plurality of importance levels; applies a first set of timer configurations of the plurality of sets for data of a radio bearer; and in response to receipt of a message from the RAN, applies a second set of timer configurations of the plurality of sets for the data of the radio bearer.

Some implementations of the method and apparatuses described herein may further include the first set of timer configurations includes a respective timer configuration for each importance level of the plurality of importance levels. Additionally or alternatively, the second set of timer configurations includes a respective timer configuration for each importance level of the plurality of importance levels. Additionally or alternatively, the UE stores the data of the radio bearer for transmission. Additionally or alternatively, the data associated with the plurality of importance levels. Additionally or alternatively, the UE receives a second signaling as the message from the RAN. Additionally or alternatively, the message includes a congestion indication. Additionally or alternatively, the UE starts a timer in response to receipt of the data of the radio bearer from an upper layer. Additionally or alternatively, the UE sets a timer value for the timer according to a first timer configuration based on the data received from the upper layer being associated with a first importance level. Additionally or alternatively, the UE sets a timer value for the timer according to a second timer configuration based on the data received from the upper layer being associated with a second importance level. Additionally or alternatively, the UE restarts the timer in response to receipt of the message from the RAN.

In some implementations of the method and apparatuses described herein, a base station transmits, to a UE, a first signaling as a configuration that indicates a plurality of sets of timer configurations for a plurality of importance levels; and transmits, to the UE, a second signaling as a message that includes a congestion indication.

Some implementations of the method and apparatuses described herein may further include a first set of timer configurations of the plurality of sets includes a respective timer configuration for each importance level of the plurality of importance levels. Additionally or alternatively, a second set of timer configurations of the plurality of sets includes a respective timer configuration for each importance level of the plurality of importance levels. Additionally or alternatively, a set of timer configurations includes a first timer configuration indicating a first timer value for transmissions of data of a radio bearer of the UE according to a first importance level. Additionally or alternatively, the set of timer configurations includes a second timer configuration indicating a second timer value for transmissions of the data of the radio bearer of the UE according to a second importance level.

### BRIEF DESCRIPTION OF THE DRAWINGS

FIG. 1 illustrates an example of a wireless communications system that supports discard timer enhancements for XR communications in accordance with aspects of the present disclosure.

FIG. 2 illustrates an example of a mapping for XR communication, as related to discard timer enhancements for XR communications in accordance with aspects of the present disclosure.

FIG. 3 illustrates an example of an alternative mapping for lower layer handling of XR communications, as related to discard timer enhancements for XR communications in accordance with aspects of the present disclosure.

FIGS. 4A and 4B an example implementation (e.g., ASN-1 code) that includes information (e.g., DiscardTimerExt3-r18) about multiple PDCP discardTimer configurations for the supported PSI levels for a PDCP entity, which supports discard timer enhancements for XR communications in accordance with aspects of the present disclosure.

FIG. 5 illustrates an example of handling PDUs pending in a UE for transmission, which supports discard timer enhancements for XR communications in accordance with aspects of the present disclosure.

FIGS. 6 and 7 illustrate an example of a block diagram of devices that supports discard timer enhancements for XR communications in accordance with aspects of the present disclosure.

FIGS. 8-10 illustrate flowcharts of methods that support discard timer enhancements for XR communications in accordance with aspects of the present disclosure.

### DETAILED DESCRIPTION

In a wireless communications system, a QoS flow and/or radio bearer for XR traffic may carry PDU sets with different importance levels (e.g., I-frames and P-frames of a video stream). According to traditional QoS architectures, all data packets of a radio bearer typically receive the same QoS treatment. For example, a UE may treat all PDUs of a logical channel (LCH) and/or radio bearer in a same manner in terms of QoS even though there may be PDUs/PDU sets associated with different importance levels. For instance, when UL of the air interface is congested, the UE still tries to transmit low importance data even though the application may not be able to make use of such low importance data (e.g. user experience is not benefitting from some “out-dated” low importance data).

In aspects of discard timer enhancements for XR communications, this disclosure describes details that allow for distinguished handling (e.g., layer 2 procedures, mechanisms, etc.) of PDU sets associated with a high importance level in certain scenarios (e.g., prioritization of high importance data and discarding of low importance data in cases of congestion, etc.). For UE may apply a first set of timer configurations (e.g., during a normal network conditions). Furthermore, if the UE receives a congestion indication from the RAN for example or alternatively if the UE detects a congestion on the air interface (e.g., UL), the UE may apply a second set of discard timer configurations.

In further aspects of discard timer enhancements for XR communications, this disclosure provides details for discarding in case of congestion. In examples, a network (NW) configures different PDCP discard timer configurations and/or durations for a radio bearer (e.g. one PDCP discard timer configuration and/or duration per importance level or PSI). In examples, the NW configures multiple PDCP discard timer configurations and/or durations for a radio bearer respectively for each PSI (importance level) supported by the radio bearer (e.g., one PDCP discard timer configuration and/or duration for “normal” mode of operation and one for “congestion mode”). In examples, the NW signals to a UE the mode to use for PDCP discarding. In an example, the NW indicates congestion and the UE switches the PDCP discard timer configuration upon reception of the notification. In an alternative or additional example, the UE considers the PDCP discard timer of low importance data as expired in case congestion is detected or when a congestion notification is received from a base station (e.g., gNB).

In further aspects of discard timer enhancements for XR communications, this disclosure provides details for importance handling for PDUs not belonging to a PDU set. For example, a UE uses a predefined “default” PSI value (e.g., importance level) for PDUs not belonging to a PDU set.

In further aspects of discard timer enhancements for XR communications, this disclosure provides details for selective enabling of PDCP duplication based on importance level. In examples, a UE enables PDCP duplication for PDUs of a PDU set based on their associated importance level or PSI. In an example, a gNB configures the UE by indicating importance levels (or PSI) for which the UE is to enable PDCP duplication.

In further aspects of discard timer enhancements for XR communications, this disclosure provides details for delaying information reported within buffer status reporting (BSR) accounts for any tethering delay. In examples, the delay information reported within a BSR accounts for a delay that a PDU and/or PDU set has experienced over a tethering link. In an example, time stamps are included within the data packet or protocol layer header in order to measure the delay of the tethering link.

In further aspects of discard timer enhancements for XR communications, this disclosure provides details for avoiding or reducing congestion over an air interface (e.g., for UL transmissions), by configuring multiple PDCP discard timer configurations associated with importance levels of PDUs and/or PDU sets.

In further aspects of discard timer enhancements for XR communications, this disclosure provides details for various processes (e.g., layer 2 procedures, etc.) that enable a differentiation of PDUs and/or PDU sets of a radio bearer associated with different importance levels. For example, a base station (e.g., gNB) configures different discard timer configurations for PDU sets that have different PSIs. In additional or alternative examples, different discard timer configurations are used when congestion is detected (e.g., compared to a “normal” mode of operation) in order to discard low importance data in the event of congestion on the air interface (e.g., low importance data is discarded in order to free-up resources for the transmission of high priority data).

In further aspects of discard timer enhancements for XR communications, this disclosure provides details for a NW that configures a PDCP discard timer configuration per importance level for a radio bearer and/or PDCP entity. In an example, where a radio bearer (e.g., data radio bearer) carries PDU sets associated with different importance levels, the NW may configure the PDCP entity of that radio bearer with multiple PDCP discard timer configurations (e.g., one for each importance level).

In further aspects of discard timer enhancements for XR communications, this disclosure provides details for a NW that configures multiple PDCP discard timer configurations for a radio bearer respectively for each PSI level supported by the radio bearer. In one example, the NW configures two discard timer configurations and/or durations per PSI for one radio bearer. One configuration and/or duration, for example, represents the PDCP discard timer duration to be used during “normal” operation (e.g., also referred to as first mode of operation) and the other configuration and/or duration is to be used by the UE for cases when UL congestion has been detected by the UE respectively NW notified the UE about a congestion on the UL air interface (e.g. also referred to as second mode of operation).

By adjusting discard timer configurations on the basis of importance level and/or network conditions, a communication device may experience improved user experience, low latency, and/or high reliability for wireless communications, especially with respect to use cases such as XR communications and/or other types of high throughput data communications (e.g., video and/or audio streaming).

Aspects of the present disclosure are described in the context of a wireless communications system. Aspects of the present disclosure are further illustrated and described with reference to device diagrams and flowcharts.

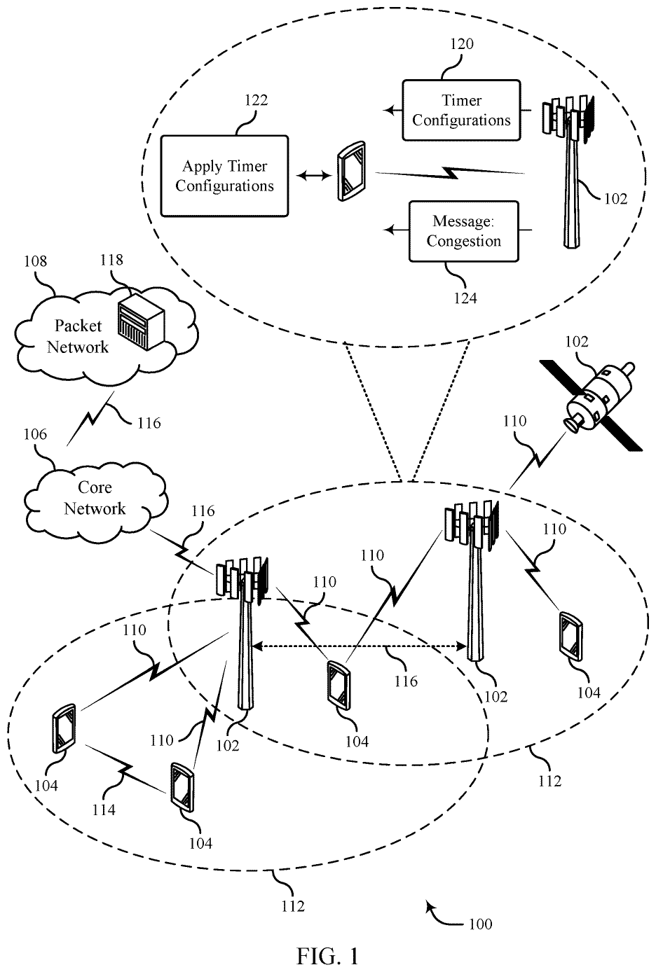

FIG. 1 illustrates an example of a wireless communications system 100 that supports discard timer enhancements for XR communications in accordance with aspects of the present disclosure. The wireless communications system 100 may include one or more network entities 102, one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as a new radio (NR) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a RAN, a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite (e.g., a non-terrestrial station (NTS)) associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, N6, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., Radio Resource Control (RRC), service data adaption protocol (SDAP), PDCP). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, N6, or another network interface). The packet data network 108 may include an application server 118. In some implementations, one or more UEs 104 may communicate with the application server 118. A UE 104 may establish a session (e.g., a protocol data unit (PDU) session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communications system 100, such as time resources (e.g., symbols, slots, subframes, frames, or the like) or frequency resources (e.g., subcarriers, carriers) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (i.e., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. The first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. Each slot may include a number (e.g., quantity) of symbols (e.g., orthogonal frequency division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHZ-24.25 GHZ), FR4 (52.6 GHZ-114.25 GHZ), FR4a or FR4-1 (52.6 GHz-71 GHz), and FR5 (114.25 GHz-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the network entities 102 and the UEs 104 are operable to implement various aspects of discard timer enhancements for XR communications, as described herein. For instance, a network entity 102 (e.g., a base station) communicates a first signaling 120 that includes various information, such as one or more sets of timer configurations associated with a plurality of importance levels. In at least one implementation signaling 120 includes a first set of timer configurations and a second set of timer configurations. Each of the first and second set of timer configurations includes a respective timer configuration for each importance level of the plurality of importance levels. A UE 104 receives the first signaling 120 and performs a process 122 to apply the first set of timer configurations for transmissions of data of a radio bearer. The network entity 102 communicates a second signaling 124 (e.g., message) that includes various information, such as a notification or indication of congestion. The UE 104 receives the second signaling 124 and performs the process 122 to apply the second set of timer configurations (e.g., instead of the first set) for transmissions of the data of the radio bearer in response to receipt of the message 124. For example, the second set of discard timer configurations may prioritize high importance level data and discard lower importance data during the congestion period.

With reference to XR, XR is an umbrella term for different types of realities including VR, AR, MR, among other examples. VR is a rendered version of a delivered visual and audio scene. For example, the rendering is designed to mimic the visual and audio sensory stimuli of the real world as naturally as possible to an observer or user as they move within the limits defined by the application. Virtual reality usually, but not necessarily, requires a user to wear a head mounted display (HMD), to completely replace the user's field of view with a simulated visual component, and to wear headphones, to provide the user with the accompanying audio. Some form of head and motion tracking of the user in VR is usually also necessary to allow the simulated visual and audio components to be updated in order to ensure that, from the user's perspective, items and sound sources remain consistent with the user's movements. Additional means to interact with the virtual reality simulation may be provided but are not strictly necessary. In examples, AR is when a user is provided with additional information or artificially generated items or content overlaid upon their current environment. Such additional information or content will usually be visual and/or audible and their observation of their current environment may be direct, with no intermediate sensing, processing and rendering, or indirect, where their perception of their environment is relayed via sensors and may be enhanced or processed. In examples, MR is an advanced form of AR where some virtual elements are inserted into the physical scene with the intent to provide the illusion that these elements are part of the real scene.

In implementations, XR refers to various real-and-virtual combined environments and/or human-machine interactions generated by computer technology and wearables. In examples, XR includes representative forms such as AR, MR and VR and the areas interpolated among them. In examples, the levels of virtuality range from partially sensory inputs to fully immersive VR. In examples, a key aspect of XR is the extension of human experiences especially relating to the senses of existence (represented by VR) and the acquisition of cognition (represented by AR).

In some implementations, XR and configured grant (CG) use cases are characterised by quasi-periodic traffic (with possible jitter) with high data rate in downlink (DL) (e.g., video steam) combined with frequent UL (e.g., pose/control update) and/or UL video stream. In some examples, both DL and UL traffic are also characterized by relatively strict packet delay budget (PDB).

In some implementations, the set of anticipated XR and CG services has a certain variety and characteristics of the data streams (i.e., video) may change “on-the-fly”, while the services are running over NR. Therefore, for example, additional information on the running services from higher layers (e.g. the QoS flow association, frame-level QoS, ADU-based QoS, XR specific QoS etc.), may be beneficial to facilitate informed choices of radio parameters. In some described implementations, XR application awareness by UE and/or gNB improves user experience, improves NR system capacity in supporting XR services, and/or reduces the UE power consumption.

In some described implementations, an Application Data Unit (ADU) is the smallest unit of data that can be processed independently by an application (such as processing for handling out-of-order traffic data). In examples, a video frame can be an I-frame, P-frame, or can be composed of I-slices, and/or P-slices. In some examples, I-frames and/or I-slices are more important and larger than P-frames and/or P-slices. In examples, an ADU can be one or more I-slices, P-slices, I-frame, P-frame, or a combination of those.

In some described implementations, a service-oriented design herein considers XR traffic characteristics (e.g., (a) variable packet arrival rate: packets coming at 30-120 frames/second with some jitter, (b) packets having variable and large packet size, (c) B/P-frames being dependent on I-frames, (d) presence of multiple traffic/data flows such as pose and video scene in uplink) to enable more efficient (e.g., in terms of satisfying XR service requirements for a greater number of UEs, or in terms of UE power saving) XR service delivery.

With reference to packet delay budget, in some implementations, the latency requirement of XR traffic in the RAN side (e.g., air interface) is modelled as PDB. The PDB is a limited time budget for a packet to be transmitted over the air from a gNB to a UE. In some examples, for a given packet, the delay of the packet incurred in air interface is measured from the time that the packet arrives at the gNB to the time that it is successfully transferred to the UE. For example, if the delay is larger than a given PDB for the packet, then the packet violates PDB, otherwise the packet is successfully delivered. The value of PDB may vary for different applications and traffic types. In one specific example, the value of a PDB is 10-20 milliseconds (ms) depending on the application.

In some implementations, 5G arrival time of data bursts on the DL can be quasi periodic (e.g., periodic with jitter). Some example factors leading to jitter in burst arrival include varying server render time, encoder time, real time transport protocol (RTP) packetization time, link between server and 5G gateway, etc. In some implementations, simulation assumptions for XR evaluation model DL traffic arrival jitter are taken into consideration, including using truncated Gaussian distribution with mean: 0 ms, std. dev: 2 ms, range: [−4 ms, 4 ms] (baseline), [−5 ms, 5 ms] (optional),

In some implementations, applications can have a certain delay requirement on an ADU, which may not be adequately translated into packet delay budget requirements. For example, if the ADU delay budget (ADB) is 10 ms, then PDB can be set to 10 ms if all packets of the ADU arrive at the 5G system at the same time. If the packets are spread out, for example, then ADU delay budget is measured either in terms of the arrival of the first packet of the ADU or the last packet of the ADU. In either case, for example, a given ADB will result in different PDB requirements on different packets of the ADU. In some scenarios, specifying the ADB to the 5G system can be beneficial.

With reference to delay-aware communication, in implementations, if the scheduler and/or the UE is aware of delay budgets for a packet/ADU, the gNB can take this knowledge into account in scheduling transmissions (e.g., by giving priority to transmissions close to their delay budget limit and by not scheduling (e.g., UL) transmissions). In examples, the UE can also take advantage of such knowledge to determine: 1) if an UL transmission (e.g., physical uplink control channel (PUCCH) in response to physical downlink shared channel (PDSCH), UL pose, or physical uplink shared channel (PUSCH)) corresponding to a transmission that exceeds its delay budget can be dropped (additionally, e.g., the system does not necessarily need to wait for re-transmission of a PDSCH and/or keep the erroneously received PDSCH in buffer for soft combining with a re-transmission that never occurs); or 2) how much of its channel occupancy time in case of using unlicensed spectrum can be shared with the gNB.

In some examples, the remaining delay budget: 1) for a DL transmission can be indicated to the UE in a downlink control information (DCI) (e.g., for a packet of a video frame, slice, and/or ADU) or via a MAC control element (MAC-CE) (e.g., for an ADU, video frame, and/or slice); and 2) for an UL transmission can be indicated to the gNB via an UL transmission such as uplink control information (UCI), PUSCH transmission, etc.

With reference to application awareness at RAN, PDU set-related QoS aspects of XR can be conveyed to the RAN to optimize the communication such as PDU set error rate (PER), PDU set delay budget (PSDB), etc. For example, in both UL and DL, XR-Awareness contributes to optimizations of gNB radio resource scheduling and relies at least on the notions of PDU Set and Data Burst. In examples, a PDU Set is composed of one or more PDUs carrying the payload of one unit of information generated at the application level (e.g., a frame or video slice), while a Data Burst is a set of data PDUs generated and sent by the application in a short period of time. In examples, a data burst can be composed of multiple PDUs belonging to one or multiple PDU Sets.

In implementations, the following information may be provided by the CN to RAN to assist the handling of QoS flows and PDUs.

In an implementation, semi-static information for both UL and DL provided via control plane (NGAP) include: periodicity for UL and DL traffic of the QoS Flow via time-sensitive communication assistance information (TSCAI) and/or time-sensitive communication assistance container (TSCAC); traffic jitter information (e.g. jitter range) associated with each periodicity of the QoS flow. In some examples, the applicability of jitter information to UL is taken into consideration.

In an implementation, PDU Set QoS parameters include: PDU Set Error Rate (PSER), which defines an upper bound for the rate of PDU Sets that have been processed by the sender of a link layer protocol but that are not successfully delivered by the corresponding receiver to the upper layer. In some examples, a PDU set is considered as successfully delivered when all PDUs of a PDU Set are delivered successfully. Additionally or alternatively, the PDU set QoS parameters also include PDU Set Delay Budget (PSDB), i.e. time between reception of the first PDU and the successful delivery of the last arrived PDU of a PDU Set. In examples, PSDB is an optional parameter. Additionally or alternatively, PDU Set QoS parameters include PDU Set Integrated Indication (PSII) (e.g., whether all PDUs are needed for the usage of PDU set by application layer). Additionally or alternatively, the PDU set QoS parameters also include dynamic information for DL provided by user plane (GTP-U header), such as: PDU Set Sequence Number; PDU Set Size in bytes; PDU SN within a PDU Set; End PDU of the PDU Set; PDU Set Importance (e.g., parameter used to identify the importance of a PDU Set within a QoS flow, RAN may use this parameter for PDU Set level packet discarding in presence of congestion; and/or End of Data Burst indication in the header of the last PDU of the Data Burst (e.g., optional).

With reference to jitter aspects of XR, in examples, the packet arrival rate is determined by the frame generation rate (e.g., 60 frames per second (fps)). In an example, the average packet arrival periodicity is given by the inverse of the frame rate (e.g., 16.6667 ms=1/60 fps). The periodic arrival without jitter gives the arrival time at gNB for packet with index k (=1, 2, 3, . . . ) as:

$$k / F * 1000 [ ms ] ,$$

where F is the given frame generation rates (per second).

However, in some examples of a real system, the varying frame encoding delay and network transfer time introduces jitter in packet arrival time at gNB. In this model, the jitter is modelled as a random variable added on top of periodic arrivals. The jitter follows truncated Gaussian distribution with following statistical parameters shown in Table 1 below.

TABLE 1
Statistical parameters for jitter

| | | Baseline value | Optional value |
|---|---|---|---|
| Parameter | Unit | for evaluation | for evaluation |
| Mean | ms | 0 | |
| STD | ms | 2 | |
| Truncation range | ms | [−4, 4] | [−5, 5] |

Note that in some examples the given parameter values and considered frame generation rates (60 or 120 in this model) ensure that packet arrivals are in order (e.g., arrival time of a next packet is always larger than that of the previous packet). For example, the periodic arrival with jitter gives the arrival time for packet with index k (=1, 2, 3 . . . ) as:

$$offset + k / F * 1000 + J [ ms ] ,$$

where F is the given frame generation rates (per second) and J is a random variable capturing jitter. Note that actual traffic arrival timing of traffic for each UE could be shifted by the UE specific arbitrary offset.

With reference to dynamic adaptation of discontinuous reception (DRX) parameters and/or configuration, in some examples, a DCI (e.g., within DRX active time) can indicate to update one or more of C-DRX cycle, OnDurationTimer, or InactivityTimer (e.g., for the current or upcoming DRX cycle). For instance, DCI signaling within the active time of a DRX cycle may indicate such update. Aspects of this disclosure include details for such DCI signaling, corresponding timelines, UE behaviours and/or actions, and/or updates on other DRX configuration parameters and/or timers needed in response to receiving the DCI indicating an update to a DRX parameter and/or timer.

With reference to multiple simultaneous DRX configurations, the network can enable multiple simultaneous DRX configurations to a UE, wherein different DRX configurations are almost aligned with arrival of different traffic flows. In an example, each DRX configuration can be configured with the traffic periodicity and the DRX cycle start can be aligned with the expected application packet arrival (or start of the jitter range) of one specific traffic flow. In an example, regardless of the DRX parameter values selected for each configuration, the multi-flow DRX solution works as follows: the UE monitors the PDCCH while the drx-onDurationTimer (or drx-InactivityTimer) is running in any of the DRX configurations (e.g., the overall active time is a logical ‘OR’ of the active times given by each DRX configuration); and/or if a PDCCH is received for a new transmission, then any drx-InactivityTimer that is running at that time could be re-started.

In aspects of this disclosure, mapping options for XR-communication are taken into consideration. One possible mapping option for XR-communication includes that PDU sets of different importance levels are mapped to a same QoS flow and radio bearer. One example of such mapping option would be for example that I-frame and P-frames of a video stream are carried by the same QoS flow/radio bearer.

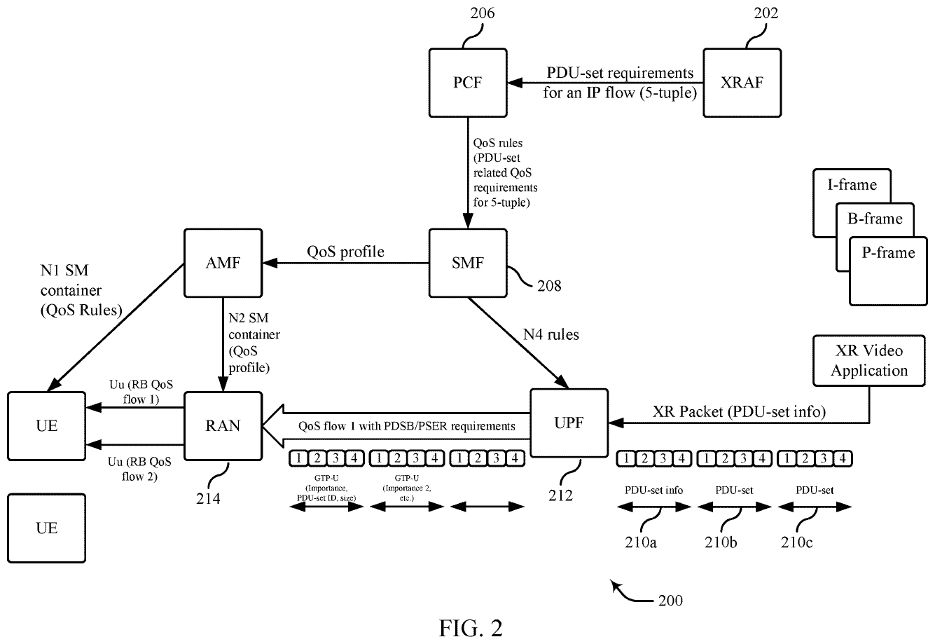

FIG. 2 illustrates an example 200 of a mapping option where I-frame and P-frames of a video stream are carried by the same QoS flow/radio bearer, as related to discard timer enhancements for XR communications. With reference to FIG. 2, a PDU set integrated handling indication indicates whether all PDUs are needed for the usage of PDU-set by application layer. Additionally or alternatively, PDU-set importance is a parameter used to identify the importance of a PDU set within a QoS flow (e.g., RAN may use it for PDU set level packet discarding in presence of congestion).

In some examples, the PDU set delay budget (PDSB) defines an upper bound for the delay that a PDU set may experience for the transfer between the UE and the N6 termination points at UPF 212 (e.g., time between reception of the first PDU and the successful delivery of the last arrived PDU of a PDU set). In examples, the PDSB applies to the DL PDU set received by the UPF 212 over the N6 interface and to the UL PDU set sent by the UE. In examples, for a certain 5QI, the value of the PSDB is the same in UL and DL. In examples, to enable support for PDSB, it may be assumed that there is a maximum duration threshold for inter arrival time between PDUs and first arrived PDU within the PDU set as per SLA or pre-configuration. In examples, a scenario where a maximum duration threshold is not met is taken into consideration. In some examples, PSDB is an optional parameter. For example, if PCF 206 has sufficient information to determine the PSDB, the PSDB is used to support the configuration of scheduling and link layer functions.

In some examples, the PSER defines an upper bound for the rate of PDU sets that have been processed by the sender of a link layer protocol (e.g., RLC in RAN) but that are not successfully delivered by the corresponding receiver to the upper layer (e.g., PDCP in RAN). Thus, in examples, the PSER defines an upper bound for a rate of non-congestion related packet losses. In examples, the PSER allows for appropriate link layer protocol configurations (e.g., RLC and HARQ in RAN). For every 5QI, in examples, the value of the PSER is the same in UL and DL. In some examples, if any PDU within the PDU set is not successfully transmitted, the PDU set is treated as error. In some examples, a PDU set is considered a successfully delivered when all PDUs of a PDU set are delivered successfully.

In the illustrated example, XRAF 202 determines PDU-set requirements. Example PDU set QoS parameters include: PDSB, PSER, PDU-set integrated indication (e.g., all PDUs of pdu-set). In examples, the PDU-set requirements include a burst periodicity (e.g., which may include frame rate values); and a description of service protocol (e.g., indicates RTP and/or real time streaming protocol (RTSP) header type to be used for PDU set identification at user plane function (UPF) 212). In examples, the description of service protocol may include a payload type (e.g., UPF 212 may not necessarily be media aware). In some examples, AF 202 may not necessarily provide jitter information. In examples, policy control function (PCF) 206 determines QoS rules for the PDU-set. In examples, session management function (SMF) 208 receives the QoS rules. A QoS profile of QoS flow may include the PDSB and PSER information. In examples, the SMF 208 tells UPF 212 to enable PDU-set inspection and how to route PDU-set packets. In examples, SMF 208 sends the QoS include to RAN via NGAP message one or more of the following: periodicity of UL and DL traffic of the QoS flow which can include frame values (e.g., 15, 20, 30, 45, 60, 72, 90, 120 FPS); jitter range associated with each periodicity (e.g., UPF 212 derives jitter based on implementation per periodicity); and/or (optional) end of burst indication.

In the illustrated example, UPF 212 receives (from XR Video application), the XR packets 210a, 210b, 210c which include DU-set information corresponding to, respectively, the I-frame, B-frame, P-frame. For example, an RTP header extension of XR packet 210a includes PDU-set information (e.g., importance, size). In examples, the XR packet 210a may also include options for HTTP/Masque and/or GTP-U out. In examples, UPF 212 determines PDU set from XR packets (e.g., different options) and routes packets to a corresponding QoS flow according to N4 Rules. In some examples, UPF 212 also identifies importance of PDU-set. In some examples, SMF 208 and/or UPF 212 calculates jitter.

In the illustrated example, the RAN 214 receives QFIs and/or QoS profile of QoS flow from SMF 208 (e.g., via AMF) during PDU session establishment and/or modification which includes PDSB and PSER. In examples, RAN 214 inspects GTP-U headers and ensures all packets of the same PDU set are handled according to the QoS profile. In some described implementations, RAN 214 may drop lower importance PDU-sets if they cannot be delivered to the UE in time (e.g., different importance level or a flag). In some examples, RAN 214 marks start and end PDU of PDU set and ensures PDU set is delivered to the UE taking into account jitter according to PDSB requirements (e.g., jitter may be an assumed value based on an SLA agreement). In some examples, when RAN 214 receives last PDU of PDU-set, then RAN delivers the PDU-set according to PDSB.

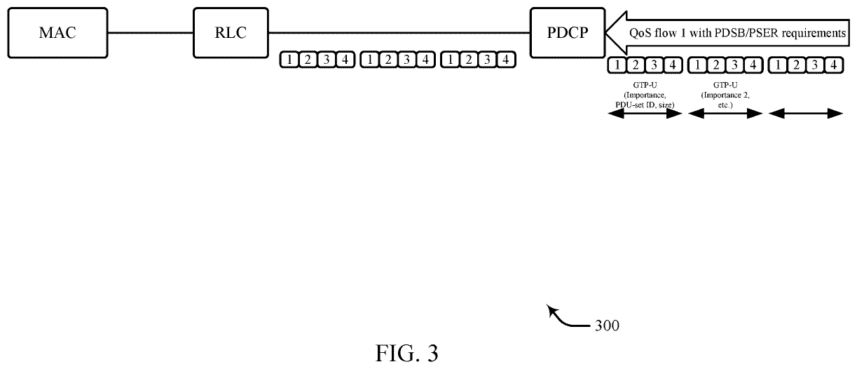

FIG. 3 illustrates an example 300 of an alternative mapping option for lower layer mapping and/or handling, as related to discard timer enhancements for XR communications. With reference to FIG. 3, a QoS flow and/or radio bearer for XR traffic may carry PDU sets with different importance levels (e.g., I-frames and P-frames) of a video stream.

In aspects of discard timer enhancements for XR communications, a NW configures a PDCP discard timer configuration per importance level for a radio bearer and/or PDCP entity. For cases where a radio bearer (e.g., data radio bearer) carries PDU sets associated with different importance levels for example, the NW may configure the PDCP entity of that radio bearer with multiple PDCP discard timer configurations (e.g., one for each importance level). In some examples, the PDCP discardTimer is configured for data radio bearers (DRBs). For example, the duration of the timer is configured by upper layers (e.g., RRC signalling).

In implementations, the PSI identifies the relative importance of a PDU Set compared to other PDU Sets within a QoS Flow respectively radio bearer. In examples, the UE identifies PDU Sets and corresponding PSI of a PDU set. In an example, the NW configures for each PSI level a corresponding PDCP discard timer configuration (e.g. PDCP discard timer durations). In an example, the NW (e.g., gNB) is informed about the different PSI values and/or levels supported for a radio bearer (e.g., gNB is provided with the different PSI values and/or levels that PDU sets of the radio bearer may be associated with). In an example, the information on the supported PSI levels and/or values may be provided by the CN to RAN as part of the semi-static information which is provided on a per QoS-flow level.

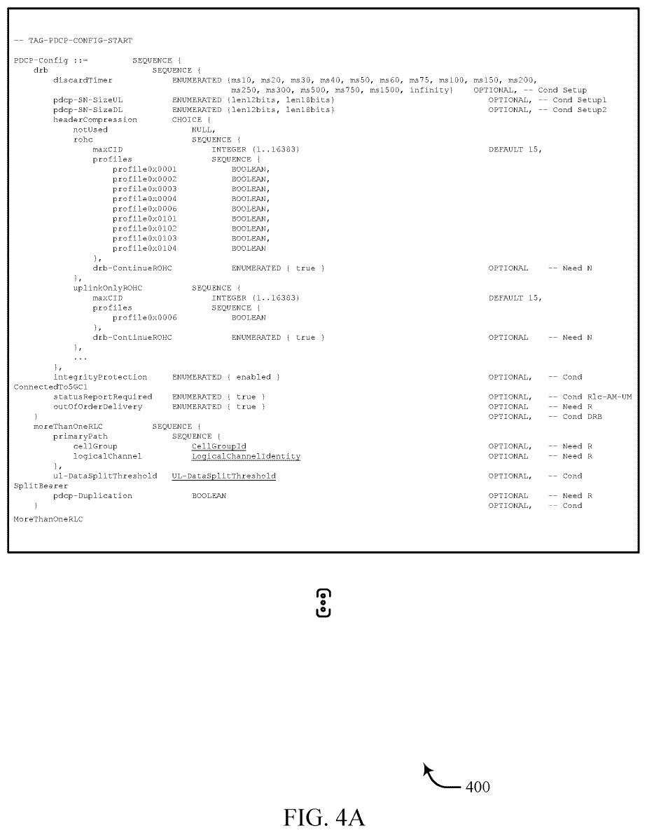

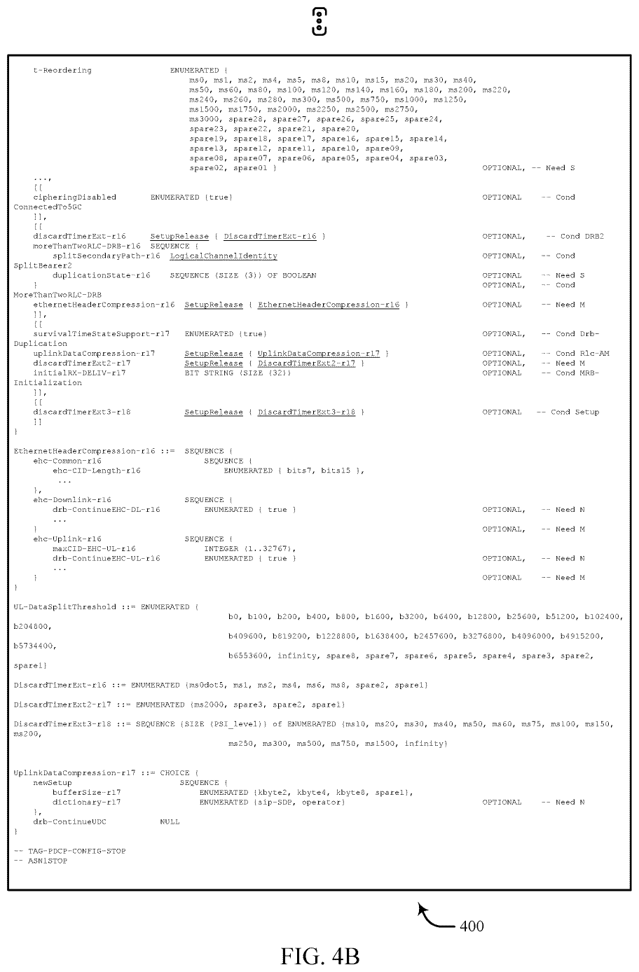

FIGS. 4A and 4B illustrate an example 400 implementation (e.g., ASN-1 code) that includes information (e.g., DiscardTimerExt3-r18) about multiple PDCP discardTimer configurations for the supported PSI levels for a PDCP entity, which supports discard timer enhancements for XR communications in accordance with aspects of the present disclosure. With reference to FIGS. 4A-4B, the information element (IE) PDCP-Config is used to set the configurable PDCP parameters for signaling, multicast and broadcast services (MBS), and data radio bearers. With reference to FIGS. 4A-4B, certain PDCP-Config field descriptions are presented below.

cipheringDisabled: if included, ciphering is disabled for this DRB regardless of which ciphering algorithm is configured for the SRB/DRBs. In examples, field may only be included if the UE is connected to 5GC. Otherwise, the field is absent. In examples, the network configures all DRBs with the same PDU-session ID with same value for this field. In some examples, the value for this field is configured to remain unchanged after the DRB is set up.

discardTimer: In examples, value ms10 corresponds to 10 ms, value ms20 corresponds to 20 ms, and so on. In some examples, value for this field is configured to remain unchanged in case of reconfiguration with sync (e.g., if the bearer is configured as DAPS bearer).

discardTimerExt: Value in ms of discardTimer as described above. In an example, value ms0dot5 corresponds to 0.5 ms, value ms1 corresponds to 1 ms, and so on. If this field is present, in implementations, the field discardTimer is ignored and discardTimerExt is used instead.

discardTimerExt2: Value in ms of discardTimerExt as described above. In an example, value ms2000 corresponds to 2000 ms. If this field is present, in implementations, the field discardTimer and discardTimerExt are ignored and discardTimerExt2 is used instead.

discardTimerExt3: value in ms of discardTimer as described above. In an example, value ms10 corresponds to 10 ms, value ms20 corresponds to 20 ms, and so on. If this field is present, in implementations, the field discardTimer, discardTimerExt and discardTimerExt2 are ignored and discardTimerExt3 is used instead.

PSI_level: number of importance levels (PSI) supported for the data radio bearer.

In an implementation, the first entry in the list of PDCP discard timer durations refers to the PDCP discard timer duration for the lowest importance level (PSI value). In examples, the second entry in the list of PDCP discard timer durations-if there are more than one entries in the list-refers to the PDCP discard timer duration for the next higher importance level (PSI value) and so on.

In an implementation, the first entry in the list of PDCP discard timer durations refers to the PDCP discard timer duration corresponding to the highest importance level (PSI value). In examples, the second entry in the list of PDCP discard timer durations-if there are more than one entries in the list-refers to the PDCP discard timer duration corresponding to the second highest importance level (PSI value) and so on.

In an implementation, the UE determines, based on the PSI (e.g., importance level) associated with a PDU set, the corresponding PDCP discard timer duration which should be used for the PDUs/SDUs of a PDU set. In an example, the PSI associated with a PDU set is provided to the PDCP entity/layer by higher layer. In some examples, the UE identifies PDU sets and the corresponding PSI. For example, the UE starts a new PDCP discard timer with the duration corresponding to PSI of the PDU set and/or service data unit (SDU) upon reception of an SDU from upper layer. Alternatively, in examples, the UE starts a new timer with the corresponding duration, (e.g., duration associated with the importance (PSI) of the corresponding PDU set) upon reception of the first SDU of an PDU set from upper layer (e.g., for cases when there is one PDCP discard timer maintained per PDU set).

In implementations, a NW configures multiple PDCP discard timer configurations (e.g., multiple different PDCP discard timer durations) for a radio bearer/PDCP entity respectively for each PSI level supported by the radio bearer. In an example, the NW configures 2 discard timer configurations and/or durations per importance level (PSI) for one radio bearer. For example, one configuration and/or duration represents the PDCP discard timer duration to be used during “normal” operation (e.g., also referred to as first mode of operation), and another configuration and/or duration to be used by the UE for cases when UL congestion has been detected and/or in response to the NW notifying the UE about a congestion on the UL air interface (e.g., also referred to as second mode of operation).

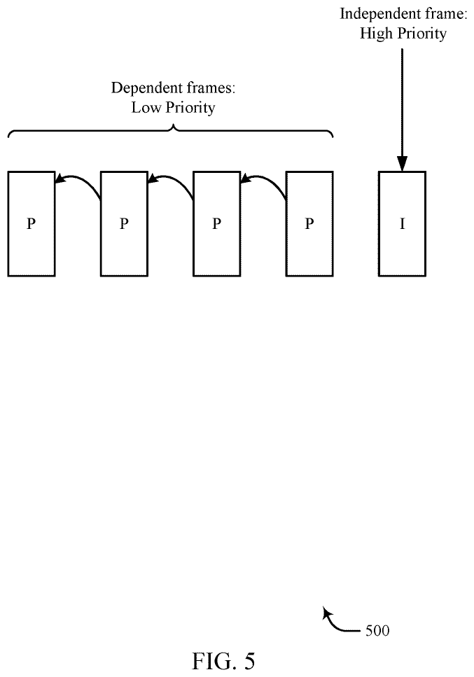

FIG. 5 illustrates an example 500 of handling PDUs pending in a UE for transmission, which supports discard timer enhancements for XR communications in accordance with aspects of the present disclosure. In aspects of this disclosure, the importance of an PDU set (PSI) may be used for the discarding operation during congestion. In some implementations, if the UL air interface is congested and UL transmission resources are not available for every PDU or SDU pending in the buffer for transmission, a UE is configured to prioritize high importance data and discard low importance data and/or PDU sets. For real-time applications like real-time video application, in some examples, PDUs pending in the UE for transmission corresponding to an older video frame may be irrelevant to the real time video stream. Furthermore, for example, since there may be no reason for transmitting them any longer, those PDUs and/or SDUs can instead be dropped as illustrated in FIG. 5 to help ease congestion in the network while improving the end-user experience of the real time video stream.

In the illustrated example, for cases when new high priority data arrives in UE's buffer and has been transmitted (e.g., I-frame) in the UL, there may be no reason to transmit further pending low importance data (e.g., P-frame) which is dependent on the previous I-frame. To reduce the congestion level on the air interface, an example UE of this disclosure is configured to discard the “outdated” low importance data thereby and additionally or alternatively to use the radio resources for the transmission of the high importance PDUs/SDUs (P-frames) which are related to the current I-frame.

In an implementation, the UE (transmitter) restarts any running PDCP discard timer with the duration associated with the corresponding mode (e.g., second mode of operation) upon detection of a congestion on the air interface or upon reception of a notification from a network entity (e.g., gNB). In an example, the UE accounts for the time already elapsed while the timer was running when restarting the timer upon mode change. For example, when a timer was already running for x ms, UE restarts the timer (e.g., upon detection or notification of a mode change) with the timer set to the duration associated with the updated mode minus x ms.

In implementations, a message from a network entity (e.g., gNB) to a UE which is used to control the discard timer handling in the UE for uplink is provided. In an example, the message provides information on the congestion level for the air interface (e.g., Uu interface). In an example, the information informs about congestion occurring on the air interface for the uplink. In an example, the message causes the UE to switch between different PDCP discard timer durations and/or configurations. In an example, the message is transmitted via a MAC control element.

In an implementation, the message includes one or more of: an indication that there is/there is no longer congestion on the air interface (Uu interface) for UL/DL transmissions; an indication to activate or deactivate a “congestion mode” behavior at the UE; an indication to the UE of which PDCP discard timer configuration and/or duration to use for a radio bearer (e.g., for cases when UE is configured with two or multiple discard timer configurations and/or durations per radio bearer or per importance level (PSI) supported by a radio bearer); and/or an indication of a LCH identifier (ID) for which the UE should switch the discard timer configuration and/or duration.

In an example, the message is indicated within a DCI. In an example, a group-common DCI may be used for the signaling of the new message (e.g., a group radio network temporary identifier (RNTI) is used for masking the cyclic redundancy check (CRC) of the DCI). In an example, the UE starts a new timer in response to reception of a message from gNB indicating congestion on the (UL) air interface and/or upon detection of congestion on the air interface. While the timer is running, UE operates according to the “congestion mode” behavior (e.g. using a different discard timer duration—as configured—or discarding PDCP SDUs/PDUs of a PDU set associated with a low importance (PSI)). Upon expiration of the new timer, UE switches back to the “normal mode” behavior (e.g., using a corresponding discard timer configuration and/or duration).

In implementations, a UE considers the PDCP discard timer of a PDCP SDU of a PDU set associated with a low importance level as expired upon detection of a congestion. In an example, the UE considers the PDCP discard timer of a PDCP SDU/PDU of a PDU set associated with a low importance as expired in response to receiving a notification from NW indicating “congestion”. In an example, the importance level(s) for which UE should consider the PDCP discard timer as expired upon detection of congestion at the UE or upon reception of a notification from gNB is preconfigured (e.g., RRC signaling) or predefined. In an example, the UE considers the PDCP discard timer of PDCP SDUs of a PDU set associated with the lowest importance levels as expired upon detection of congestion. In an example, the UE uses a discard timer duration of 0 ms for PDCP SDUs of a PDU set associated with a low importance (PSI) (e.g., lowest importance level) upon detection of a congestion and/or upon reception of a notification from gNB. In an example, the UE considers the air interface (e.g., UL) as congestion for cases when the amount of data for a LCH or radio bearer available for transmission exceeds a predefined threshold.

In implementations, a UE indicates a cause value when indicating unused CG PUSCH resources (e.g., by signaling of CG-UCI). In an example, the cause value refers to a set of different causes. In examples, the cause value indicates one or more of the following. “congestion”: indicating that the PDU of a PDU set was discarded and CG PUSCH transmission not performed due to congestion. “PDU loss”: since at least one PDU of a PDU set is determined to be “lost”, there is no point in transmitting further remaining PDU(s) of the PDU set. “Data availability”: indicating that there is no further data in UEs buffer available for transmission.

In implementations, a UE uses a default importance level (PSI) for PDCP SDUs which are not belonging to a PDU set. In an example, the importance level (PSI) to be used for PDCP SDUs not belonging to a PDU set is preconfigured (e.g., RRC signaling). In an example, the UE uses the highest importance level for PDCP SDUs and/or PDUs not belonging to a PDU set. In an example, the UE uses the lowest importance level (PSI) for PDCP SDUs/PDUs not belonging to a PDU set.

In implementations, the delay information reported within a buffer status report takes into account the time a PDU/PDU set experienced for a tethering link. In examples, this disclosure supports tethering use cases for XR (e.g., AR glasses may be tethered through non-5G connectivity (wired, WiFi) or through 5G connectivity). In an example, the reported remaining delay budget information includes the time a PDU and/or PDU set spent on the tethering link. In an example, the application or some higher layer protocol includes time stamps for a PDU, PDU set, and/or data packet in order to allow measuring the time in the UE the packet, PDU, and/or PDU elapsed since its generation. In an example, the time stamps are included in the RTP header. In an example, the UE assumes a given average delay for the tethering interface when reporting the remaining delay budget within buffer status report information. In an example, the UE reports an average link delay (average delay of the tethering link) to the NW (e.g., gNB). In an example the average link delay is reported within a MAC control element. In an example, the average link delay is reported as part of the UE assistance information.

In implementations, a UE enables selective duplication (PDCP duplication) based on the importance level (PSI) associated with a PDU and/or PDU set. In an example, the UE enables PDCP duplication for PDCP SDUs and/or PDUs having a predefined associated importance level (PSI) (e.g., the PDU set to which the SDU/PDU belongs has the predefined associated PSI). Upon identifying the PSI of an PDCP SDU being received from upper layer, in examples, the UE determines whether the PSI value corresponds to one of the predefined PSI levels. For example, if the PSI level of the PDU set and/or SDU is equal to one of the set of predefined PSI levels, the UE and/or PDCP entity enables PDCP duplication for the entire PDU set. In an example, the NW configures whether selective duplication based on PSI level is applied or not. In an example, a network entity (e.g., gNB) configures for which PSI levels PDCP entity and/or UE should enable PDCP duplication (e.g., via RRC signaling). In an example, a new configuration is signaled within the IE PDCP-Config, which is used to set the configurable PDCP parameters for signaling, MBS multicast, and/or data radio bearers. In an example, the UE enables a NACK-based PDCP duplication selective duplication (PDCP duplication) based on the importance level (PSI) associated with a PDU and/or PDU set. Only for PDU sets of a certain predefined/preconfigured importance level (PSI) UE enables PDCP duplication based on the reception of a NACK, e.g. upon reception of a DCI scheduling a retransmission.

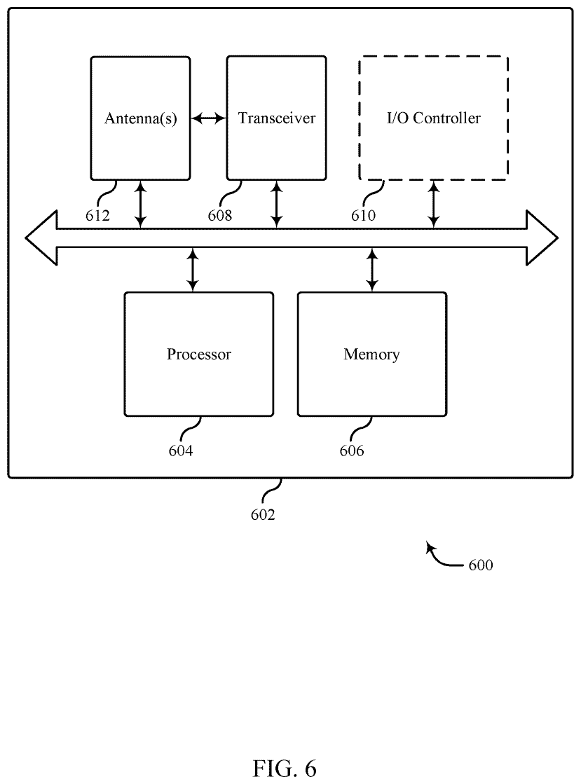

FIG. 6 illustrates an example of a block diagram 600 of a device 602 that supports discard timer enhancements for XR communications in accordance with aspects of the present disclosure. The device 602 may be an example of a UE 104 as described herein. The device 602 may support wireless communication with one or more network entities 102, UEs 104, or any combination thereof. The device 602 may include components for bi-directional communications including components for transmitting and receiving communications, such as a processor 604, a memory 606, a transceiver 608, and an I/O controller 610. These components may be in electronic communication or otherwise coupled (e.g., operatively, communicatively, functionally, electronically, electrically) via one or more interfaces (e.g., buses).

The processor 604, the memory 606, the transceiver 608, or various combinations thereof or various components thereof may be examples of means for performing various aspects of the present disclosure as described herein. For example, the processor 604, the memory 606, the transceiver 608, or various combinations or components thereof may support a method for performing one or more of the operations described herein.

In some implementations, the processor 604, the memory 606, the transceiver 608, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 604 and the memory 606 coupled with the processor 604 may be configured to perform one or more of the functions described herein (e.g., executing, by the processor 604, instructions stored in the memory 606).

For example, the processor 604 may support wireless communication at the device 602 in accordance with examples as disclosed herein. The processor 604 may be configured as or otherwise support a means for receiving a first signaling as a configuration from a RAN, the configuration indicating a plurality of sets of timer configurations for a plurality of importance levels; applying a first set of timer configurations of the plurality of sets for data of a radio bearer; and in response to receipt of a message from the RAN, applying a second set of timer configurations of the plurality of sets for the data of the radio bearer.

Additionally, the processor 604 may be configured as or otherwise support any one or combination of the first set of timer configurations includes a respective timer configuration for each importance level of the plurality of importance levels. Additionally or alternatively, the second set of timer configurations includes a respective timer configuration for each importance level of the plurality of importance levels. Additionally or alternatively, means for storing the data of the radio bearer for transmission, the data associated with the plurality of importance levels. Additionally or alternatively, means for receiving a second signaling as the message from the RAN. Additionally or alternatively, the message includes a congestion indication. Additionally or alternatively, means for starting a timer in response to receipt of the data of the radio bearer from an upper layer. Additionally or alternatively, means for setting a timer value for the timer according to a first timer configuration based on the data received from the upper layer being associated with a first importance level. Additionally or alternatively, means for restarting the timer in response to receipt of the message from the RAN.

Additionally or alternatively, the device 602, in accordance with examples as disclosed herein, may include the processor 604; and the memory 606 coupled with the processor 604, the processor 604 configured to cause the device 602 to: receive a first signaling as a configuration from a RAN, the configuration indicating a plurality of sets of timer configurations for a plurality of importance levels; apply a first set of timer configurations of the plurality of sets for data of a radio bearer; and in response to receipt of a message from the RAN, apply a second set of timer configurations of the plurality of sets for the data of the radio bearer.

Additionally, the wireless communication at the device 602 may include any one or combination of the first set of timer configurations includes a respective timer configuration for each importance level of the plurality of importance levels. Additionally or alternatively, the second set of timer configurations includes a respective timer configuration for each importance level of the plurality of importance levels. Additionally or alternatively, the processor 604 configured to cause the device 602 to store the data of the radio bearer for transmission. Additionally or alternatively, the data is associated with the plurality of importance levels. Additionally or alternatively, the processor 604 configured to cause the device 602 to receive a second signaling as the message from the RAN. Additionally or alternatively, the message includes a congestion indication. Additionally or alternatively, the processor 604 configured to cause the device 602 to start a timer in response to receipt of the data of the radio bearer from an upper layer. Additionally or alternatively, the processor 604 configured to cause the device 602 to set a timer value for the timer according to a first timer configuration based on the data received from the upper layer being associated with a first importance level. Additionally or alternatively, the processor 604 configured to cause the device 602 to set a timer value for the timer according to a second timer configuration based on the data received from the upper layer being associated with a second importance level. Additionally or alternatively, the processor 604 configured to cause the device 602 to restart the timer in response to receipt of the message from the RAN.

The processor 604 of the device 602 may support wireless communication in accordance with examples disclosed herein. The processor 604 includes at least one controller coupled with at least one memory, and is configured to or operable to cause the processor to receive a first signaling as a configuration from a RAN, the configuration indicating a plurality of sets of timer configurations for a plurality of importance levels; apply a first set of timer configurations of the plurality of sets for data of a radio bearer; and in response to receipt of a message from the RAN, apply a second set of timer configurations of the plurality of sets for the data of the radio bearer. The at least one controller coupled with the at least one memory may be further configured to cause the processor 604 to perform various operations described herein, such as operations described with reference to the device 602 and/or a UE 104.

The processor 604 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 604 may be configured to operate a memory array using a memory controller. In some other implementations, a memory controller may be integrated into the processor 604. The processor 604 may be configured to execute computer-readable instructions stored in a memory (e.g., the memory 606) to cause the device 602 to perform various functions of the present disclosure.

The memory 606 may include random access memory (RAM) and read-only memory (ROM). The memory 606 may store computer-readable, computer-executable code including instructions that, when executed by the processor 604 cause the device 602 to perform various functions described herein. The code may be stored in a non-transitory computer-readable medium such as system memory or another type of memory. In some implementations, the code may not be directly executable by the processor 604 but may cause a computer (e.g., when compiled and executed) to perform functions described herein. In some implementations, the memory 606 may include, among other things, a basic I/O system (BIOS) which may control basic hardware or software operation such as the interaction with peripheral components or devices.

The I/O controller 610 may manage input and output signals for the device 602. The I/O controller 610 may also manage peripherals not integrated into the device M02. In some implementations, the I/O controller 610 may represent a physical connection or port to an external peripheral. In some implementations, the I/O controller 610 may utilize an operating system such as iOS®, ANDROID®, MS-DOS®, MS-WINDOWS®, OS/2®, UNIX®, LINUX®, or another known operating system. In some implementations, the I/O controller 610 may be implemented as part of a processor, such as the processor 604. In some implementations, a user may interact with the device 602 via the I/O controller 610 or via hardware components controlled by the I/O controller 610.

In some implementations, the device 602 may include a single antenna 612. However, in some other implementations, the device 602 may have more than one antenna 612 (i.e., multiple antennas), including multiple antenna panels or antenna arrays, which may be capable of concurrently transmitting or receiving multiple wireless transmissions. The transceiver 608 may communicate bi-directionally, via the one or more antennas 612, wired, or wireless links as described herein. For example, the transceiver 608 may represent a wireless transceiver and may communicate bi-directionally with another wireless transceiver. The transceiver 608 may also include a modem to modulate the packets, to provide the modulated packets to one or more antennas 612 for transmission, and to demodulate packets received from the one or more antennas 612.

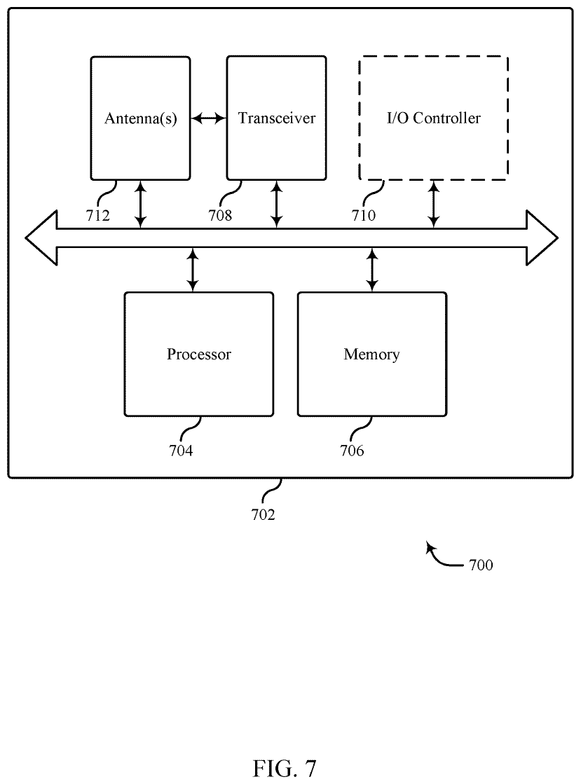

FIG. 7 illustrates an example of a block diagram 700 of a device 702 that supports discard timer enhancements for XR communications in accordance with aspects of the present disclosure. The device 702 may be an example of a network entity 102 as described herein. The device 702 may support wireless communication with one or more network entities 102, UEs 104, or any combination thereof. The device 702 may include components for bi-directional communications including components for transmitting and receiving communications, such as a processor 704, a memory 706, a transceiver 708, and an I/O controller 710. These components may be in electronic communication or otherwise coupled (e.g., operatively, communicatively, functionally, electronically, electrically) via one or more interfaces (e.g., buses).

The processor 704, the memory 706, the transceiver 708, or various combinations thereof or various components thereof may be examples of means for performing various aspects of the present disclosure as described herein. For example, the processor 704, the memory 706, the transceiver 708, or various combinations or components thereof may support a method for performing one or more of the operations described herein.

In some implementations, the processor 704, the memory 706, the transceiver 708, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 704 and the memory 706 coupled with the processor 704 may be configured to perform one or more of the functions described herein (e.g., executing, by the processor 704, instructions stored in the memory 706).

For example, the processor 704 may support wireless communication at the device 702 in accordance with examples as disclosed herein. The processor 704 may be configured as or otherwise support a means for transmitting, to a UE, a first signaling as a configuration that indicates a plurality of sets of timer configurations for a plurality of importance levels; and transmitting, to the UE, a second signaling as a message that includes a congestion indication.

Additionally, the processor 704 may be configured as or otherwise support any one or combination of first set of timer configurations of the plurality of sets includes a respective timer configuration for each importance level of the plurality of importance levels. Additionally or alternatively, a second set of timer configurations of the plurality of sets includes a respective timer configuration for each importance level of the plurality of importance levels. Additionally or alternatively, a set of timer configurations includes a first timer configuration indicating a first timer value for transmissions of data of a radio bearer of the UE according to a first importance level. Additionally or alternatively, the set of timer configurations includes a second timer configuration indicating a second timer value for transmissions of the data of the radio bearer of the UE according to a second importance level.

Additionally, or alternatively, the device 702, in accordance with examples as disclosed herein, may include a processor 704; and a memory coupled with the processor 704. The processor 704 configured to cause the device 702 to: transmit, to a UE, a first signaling as a configuration that indicates a plurality of sets of timer configurations for a plurality of importance levels; and transmit, to the UE, a second signaling as a message that includes a congestion indication.

Additionally, the wireless communication at the device 702 may include any one or combination of a first set of timer configurations of the plurality of sets includes a respective timer configuration for each importance level of the plurality of importance levels. Additionally or alternatively, a second set of timer configurations of the plurality of sets includes a respective timer configuration for each importance level of the plurality of importance levels. Additionally or alternatively, a set of timer configurations includes a first timer configuration indicating a first timer value for transmissions of data of a radio bearer of the UE according to a first importance level. Additionally or alternatively, the set of timer configurations includes a second timer configuration indicating a second timer value for transmissions of the data of the radio bearer of the UE according to a second importance level.

The processor 704 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 704 may be configured to operate a memory array using a memory controller. In some other implementations, a memory controller may be integrated into the processor 704. The processor 704 may be configured to execute computer-readable instructions stored in a memory (e.g., the memory 706) to cause the device 702 to perform various functions of the present disclosure.

The memory 706 may include random access memory (RAM) and read-only memory (ROM). The memory 706 may store computer-readable, computer-executable code including instructions that, when executed by the processor 704 cause the device 702 to perform various functions described herein. The code may be stored in a non-transitory computer-readable medium such as system memory or another type of memory. In some implementations, the code may not be directly executable by the processor 704 but may cause a computer (e.g., when compiled and executed) to perform functions described herein. In some implementations, the memory 706 may include, among other things, a basic I/O system (BIOS) which may control basic hardware or software operation such as the interaction with peripheral components or devices.

The I/O controller 710 may manage input and output signals for the device 702. The I/O controller 710 may also manage peripherals not integrated into the device 702. In some implementations, the I/O controller 710 may represent a physical connection or port to an external peripheral. In some implementations, the I/O controller 710 may utilize an operating system such as iOS®, ANDROID®, MS-DOS®, MS-WINDOWS®, OS/2®, UNIX®, LINUX®, or another known operating system. In some implementations, the I/O controller 710 may be implemented as part of a processor, such as the processor 704. In some implementations, a user may interact with the device 702 via the I/O controller 710 or via hardware components controlled by the I/O controller 710.

In some implementations, the device 702 may include a single antenna 712. However, in some other implementations, the device 702 may have more than one antenna 712 (i.e., multiple antennas), including multiple antenna panels or antenna arrays, which may be capable of concurrently transmitting or receiving multiple wireless transmissions. The transceiver 708 may communicate bi-directionally, via the one or more antennas 712, wired, or wireless links as described herein. For example, the transceiver 708 may represent a wireless transceiver and may communicate bi-directionally with another wireless transceiver. The transceiver 708 may also include a modem to modulate the packets, to provide the modulated packets to one or more antennas 712 for transmission, and to demodulate packets received from the one or more antennas 712.

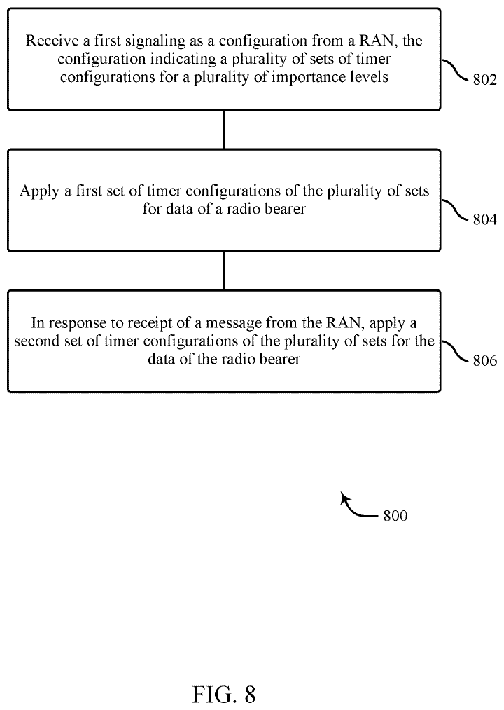

FIG. 8 illustrates a flowchart of a method 800 that supports discard timer enhancements for XR communications in accordance with aspects of the present disclosure. The operations of the method 800 may be implemented by a device or its components as described herein. For example, the operations of the method 800 may be performed by a UE 104 as described with reference to FIGS. 1 through 7. In some implementations, the device may execute a set of instructions to control the function elements of the device to perform the described functions. Additionally, or alternatively, the device may perform aspects of the described functions using special-purpose hardware.

At 802, the method may include receiving a first signaling as a configuration from a RAN, the configuration indicating a plurality of sets of timer configurations for a plurality of importance levels. The operations of 802 may be performed in accordance with examples as described herein. In some implementations, aspects of the operations of 802 may be performed by a device as described with reference to FIG. 1.

At 804, the method may include applying a first set of timer configurations of the plurality of sets for data of a radio bearer. The operations of 804 may be performed in accordance with examples as described herein. In some implementations, aspects of the operations of 804 may be performed by a device as described with reference to FIG. 1.

At 806, the method may include in response to receipt of a message from the RAN, applying a second set of timer configurations of the plurality of sets for the data of the radio bearer. The operations of 806 may be performed in accordance with examples as described herein. In some implementations, aspects of the operations of 806 may be performed by a device as described with reference to FIG. 1.

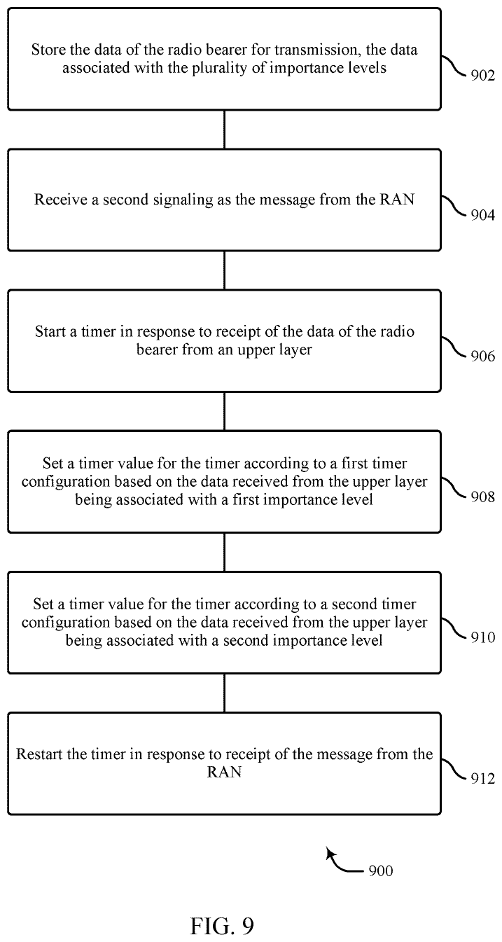

FIG. 9 illustrates a flowchart of a method 900 that supports discard timer enhancements for XR communications in accordance with aspects of the present disclosure. The operations of the method 900 may be implemented by a device or its components as described herein. For example, the operations of the method 900 may be performed by a UE 104 as described with reference to FIGS. 1 through 7. In some implementations, the device may execute a set of instructions to control the function elements of the device to perform the described functions. Additionally, or alternatively, the device may perform aspects of the described functions using special-purpose hardware.

At 902, the method may include storing the data of the radio bearer for transmission, the data associated with the plurality of importance levels. The operations of 902 may be performed in accordance with examples as described herein. In some implementations, aspects of the operations of 902 may be performed by a device as described with reference to FIG. 1.

At 904, the method may include receiving a second signaling as the message from the RAN. The operations of 904 may be performed in accordance with examples as described herein. In some implementations, aspects of the operations of 904 may be performed by a device as described with reference to FIG. 1.

At 906, the method may include starting a timer in response to receipt of the data of the radio bearer from an upper layer. The operations of 906 may be performed in accordance with examples as described herein. In some implementations, aspects of the operations of 906 may be performed by a device as described with reference to FIG. 1.

At 908, the method may include setting a timer value for the timer according to a first timer configuration based on the data received from the upper layer being associated with a first importance level. The operations of 908 may be performed in accordance with examples as described herein. In some implementations, aspects of the operations of 908 may be performed by a device as described with reference to FIG. 1.

At 910, the method may include setting a timer value for the timer according to a second timer configuration based on the data received from the upper layer being associated with a second importance level. The operations of 910 may be performed in accordance with examples as described herein. In some implementations, aspects of the operations of 910 may be performed by a device as described with reference to FIG. 1.

At 912, the method may include restarting the timer in response to receipt of the message from the RAN. The operations of 912 may be performed in accordance with examples as described herein. In some implementations, aspects of the operations of 912 may be performed by a device as described with reference to FIG. 1.

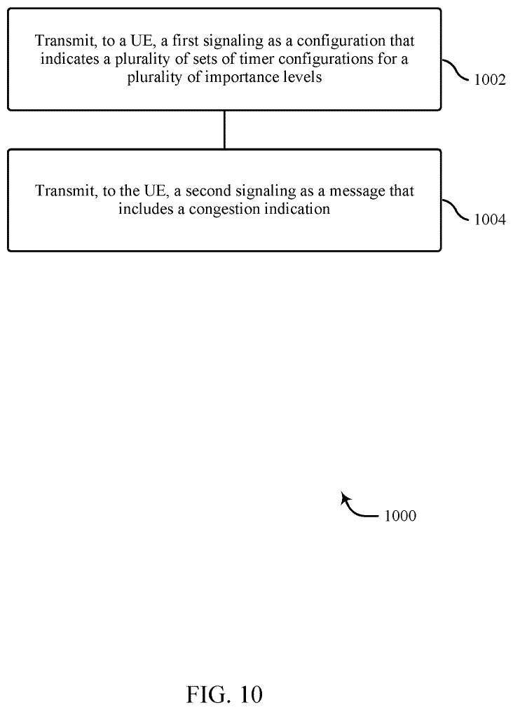

FIG. 10 illustrates a flowchart of a method 1000 that supports discard timer enhancements for XR communications in accordance with aspects of the present disclosure. The operations of the method 1000 may be implemented by a device or its components as described herein. For example, the operations of the method 1000 may be performed by a network entity 102 as described with reference to FIGS. 1 through 7. In some implementations, the device may execute a set of instructions to control the function elements of the device to perform the described functions. Additionally, or alternatively, the device may perform aspects of the described functions using special-purpose hardware.

At 1002, the method may include transmitting, to a UE, a first signaling as a configuration that indicates a plurality of sets of timer configurations for a plurality of importance levels. The operations of 1002 may be performed in accordance with examples as described herein. In some implementations, aspects of the operations of 1002 may be performed by a device as described with reference to FIG. 1.

At 1004, the method may include transmitting, to the UE, a second signaling as a message that includes a congestion indication. The operations of 1004 may be performed in accordance with examples as described herein. In some implementations, aspects of the operations of 1004 may be performed by a device as described with reference to FIG. 1.

It should be noted that the methods described herein describe possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Similarly, a list of one or more of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE) for wireless communication, comprising:
at least one memory; and
at least one processor coupled with the at least one memory and operable to cause the UE to:
receive a configuration indicating a first discard timer configuration and at least one additional discard timer configuration for a packet data convergence protocol (PDCP) entity of a radio bearer;
apply a first mode of discarding at the PDCP entity by applying the first discard timer configuration for data of the radio bearer, the data of the radio bearer is associated with multiple importance levels; and
apply a second mode of discarding at the PDCP entity by applying the first discard timer configuration and the at least one additional discard timer configuration based on the multiple importance levels of the data of the radio bearer.

2. The UE of claim 1, wherein, to apply the second mode of discarding, the at least one processor is operable to cause the UE to:
apply the first discard timer configuration for the data of the radio bearer that is associated with a first set of importance levels of the multiple importance levels; and
apply the at least one additional discard timer configuration for the data of the radio bearer that is associated with a second set of importance levels of the multiple importance levels.

3. The UE of claim 2, wherein the at least one additional discard timer configuration is applied for the data of the radio bearer that is associated with a low importance.

4. The UE of claim 1, wherein the at least one processor is operable to cause the UE to store the data of the radio bearer for transmission.

5. The UE of claim 1, wherein a signaling from a network entity is configured to activate or deactivate the second mode of discarding at the PDCP entity of the UE.

6. The UE of claim 5, wherein the signaling includes an indication of the radio bearer for which the second mode of discarding is to be activated or deactivated.

7. The UE of claim 5, wherein the at least one processor is operable to cause the UE to apply the first mode of discarding at the PDCP entity in response to the signaling including an indication to deactivate the second mode of discarding at the PDCP entity.

8. The UE of claim 1, wherein the at least one processor is operable to cause the UE to at least one of:
start a PDCP discard timer in response to receipt of the data of the radio bearer from an upper layer; or
set a timer value for the PDCP discard timer according to a first timer configuration based on the data received from the upper layer being associated with a first importance level and activation of the second mode of discarding based on a second importance level.

9. The UE of claim 8, wherein the at least one processor is operable to cause the UE to set the timer value for the PDCP discard timer according to a second timer configuration based on the data received from the upper layer being associated with a third importance level.

10. The UE of claim 8, wherein the at least one processor is operable to cause the UE to restart the PDCP timer in response to receipt of a signaling from a network entity.

11. (canceled)

12. A network entity (NE) for wireless communication, comprising:
at least one memory; and
at least one processor coupled with the at least one memory and operable to cause the NE to:
transmit, to a user equipment (UE), a configuration that indicates a first discard timer configuration and at least one additional discard timer configuration for a packet data convergence protocol (PDCP) entity of a radio bearer; and
transmit, to the UE, an indication to activate or deactivate, at the PDCP entity of the radio bearer, a mode of discarding that is based on importance levels of data of the radio bearer.

13. The NE of claim 12, wherein the indication to activate or deactivate the mode of discarding includes a congestion indication.

14. The NE of claim 12, wherein the mode of discarding that is based on the importance levels of the data of the radio bearer is a first mode of discarding the data of the radio bearer, and wherein a second mode of discarding indicates to the PDCP entity to apply the first discard timer configuration for the data associated with the importance levels.

15. The NE of claim 12, wherein activation of the mode of discarding based on the importance levels of the data indicates to the PDCP entity to:
apply the first discard timer configuration for a service data unit (SDU) in the data of the radio bearer if the SDU has a first importance level; and
apply the at least one additional discard timer configuration for the SDU if the SDU has a second importance level lower than the first importance level.

16. The NE of claim 12, wherein the at least one additional discard timer configuration is used for service data units (SDUs) or protocol data units (PDUs) in the data of the radio bearer that are associated with a low importance.

17. A method performed by a user equipment (UE), the method comprising:
receiving a configuration indicating a first discard timer configuration and at least one additional discard timer configuration for a packet data convergence protocol (PDCP) entity of a radio bearer;
applying a first mode of discarding at the PDCP entity by applying the first discard timer configuration for data of the radio bearer, the data of the radio bearer is associated with multiple importance levels; and
applying a second mode of discarding at the PDCP entity by applying the first discard timer configuration and the at least one additional discard timer configuration based on the multiple importance levels of the data of the radio bearer.

18. The method of claim 17, wherein, to apply the second mode of discarding, the method further comprising:
applying the first discard timer configuration for the data of the radio bearer that is associated with a first set of importance levels of the multiple importance levels; and
applying the at least one additional discard timer configuration for the data of the radio bearer that is associated with a second set of importance levels of the multiple importance levels.

19. The method of claim 17, wherein the second set of timer discard configurations include a respective timer configuration for each importance level of the multiple importance levels.

20. The method of claim 17, further comprising at least one of:
storing the data of the radio bearer for transmission;
receiving the second a signaling from a network entity, wherein the second signaling activates or deactivates the second mode of discarding based on the importance levels at the PDCP entity of the UE;
starting a PDCP discard timer in response to receipt of the data of the radio bearer from an upper layer;
setting a timer value for the PDCP discard timer according to a first timer configuration based on the data received from the upper layer being associated with a first importance level and the second mode of discarding based on importance levels being activated;
setting the timer value for the PDCP discard timer according to a second timer configuration based on the data received from the upper layer being associated with a second importance level and the second mode of discarding based on importance levels being activated; or
restarting the PDCP discard timer in response to receipt of the second signaling from the network entity.

21. A method performed by a network entity (NE), the method comprising:
transmitting, to a user equipment (UE), a configuration that indicates a first discard timer configuration and at least one additional discard timer configuration for a packet data convergence protocol (PDCP) entity of a radio bearer; and
transmitting, to the UE, an indication to activate or deactivate, at the PDCP entity of the radio bearer, a mode of discarding that is based on importance levels of data of the radio bearer.
